(19) United States
(12) Patent Application Publication
(10) Pub. No.: US 2021/0212282 A1
(43) Pub. Date: Jul. 15, 2021

(54) Teat Preparation System

(71) Applicants: Roy L. Rard, Conway, WA (US); Ron L. Medeiros, Littlefield, TX (US)

(72) Inventors: Roy L. Rard, Conway, WA (US); Ron L. Medeiros, Littlefield, TX (US)

(21) Appl. No.: 17/009,561

(22) Filed: Sep. 1, 2020

Related U.S. Application Data
(60) Provisional application No. 62/960,875, filed on Jan. 14, 2020.

(51) Int. Cl. A01J 7/04

(52) U.S. Cl. CPC A01J 7/04

(57) ABSTRACT

A teat preparation system that includes a lightweight, compact hand piece designed to fit around the teat on a bovine to sequentially clean, dry and apply a post-dip solution to the teat. The system includes a control unit with a software program that controls the amount and delivery timing of pressure air, pre-dip solution and post-dip solution to the hand piece. The software program operates in one of two modes. The hand piece includes switches that control the operation of the control unit that control solenoids connected to a high pressure air source, a pre dip solution source and a post-dip solution source. Located inside the hand piece is a spray cylinder with a plurality of nozzles, The shape of the spray cylinder and the orientation of the nozzles create a venturi and produces a suction that draws and stretches the teat into the spray cylinder. The hand piece and the control unit may also be configured to strip the teat after applying the pre-dip solution.

This non-provisional patent application is based on and claims the filing date benefit U.S. Provisional patent application 62/960875 filed on Jan. 14, 2020.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

### 1. Field of the Invention

This invention pertains to devices that automatically clean, dry and apply a post dip solution to the individual teats on a bovine,

### 2. Description of the Related Art

Dairy workers should follow good hygienic milking procedures to ensure the milk is safe to consume. For example, each teat should be thoroughly cleaned prior to milking. The task of cleaning is performed by a worker who stands on one side or behind the cow and applies a cleaning solution, called a ‘pre-dip solution’ or ‘pre-dip’ by spray, cup, former, or sponge. The pre-dip solution is usually an aqueous mixture containing 0.5 % iodine, or hydrogen peroxide or chlorine dioxide, or a combination thereof. Ideally, the pre-dip solution should be heated to approximately 110 to 120 degrees F. After all of the teats have been cleaned with the pre-dip solution, the worker then uses a dry towel to remove the dirt and the pre-dip solution from all of the teats Because the worker must stand to one side or behind the cow to reach the teats, areas of the teats opposite the worker are difficult to reach and often not thoroughly cleaned and dried.

Before milking, all of the teats are normally ‘stripped’ to stimulate oxytocin release. While the acts of washing and drying the teat may stimulate oxytocin release, the worker will sometimes manually squeeze and pull each teat downward to further stimulate oxytocin release. Depending on the skill of the worker, manually squeezing and pulling downward on the teats may not be sufficient to stimulate oxytocin release.

After milking, the worker then manually applies a disinfecting solution, called a ‘post dip solution’ or ‘post-dip’ that is more viscous than the pre-dip solution applier earlier. The post-dip solution contains a higher concentration of iodine than the pre-dip solution and includes glycerin that acts as a thickening agent and as an emollient to soften the teat. It is important that the post-dip solution be applied to the tip of each teat and given sufficient time to dry to and form a protective layer.

Another drawback with the above described milking process is that the quality of the milk depends on completion of the cleaning step, the pre-dip solution application step, the drying step, and the post-dip application step. If all of the steps are not followed or done insufficiently, milk from the cow may be contaminated and/or infection may set in.

Another drawback with the above described milking process is that hundreds of cloth or paper towels are used each day that must be laundered or discarded.

What is needed is a teat preparation system that uses a single, lightweight hand piece that thoroughly cleans, applies a pre-dip solution to each teat, and removes excessive pre-dip solution from each teat and eliminates the use of cloth or paper towels.

What is also needed is a such a system that also evenly applies a post-dip solution to the entire teat.

What is also needed is a teat preparation system that uses components that are reliable and have few moving parts that can break down or need repair or adjustment.

What is also needed is such a system that uses components that can be easily modified to include the task of stripping the teat after the cleaning step, the pre-dip solution application step, and the drying step have been performed and before milking.

### SUMMARY OF THE INVENTION

A teat preparation system used to automatically and selectively clean the individually the teats on a bovine with a high pressure air and a pre-dip solution and then dries each teat after applying the pre-dip solution without using towels, and is used to apply a post-dip solution to the each teat after milking.

The system includes a hand piece and a control unit. The hand piece is compact, lightweight and, configured to be held and operated with one hand. The hand piece is also made with durable components to stand up to rough use in a milking parlor. The hand piece is connected to the control unit which controls the delivery of high pressure air, pre-dip solution and post-dip solution to the hand piece. During use, the hand piece is placed under a teat and the control unit is activated which delivers high pressure air and the pre-dip solution to the hand piece. A suction force is created in the hand piece's teat receiving section with a venturi producing structure that draws the teat into the teat receiving section and evenly distributes the pre-dip solution over the entire teat.

More specifically, located inside the hand piece's teat receiving section is a spray cylinder. Formed inside the spray cylinder is a teat receiving bore configured to receive an axially aligned teat. The spray cylinder includes a narrow top opening configured to fit around the teat and a wide bottom opening through which high pressure air and the pre-dip solution are discharged. The spray cylinder includes a wide upper section near the narrow top opening in which a plurality of downward aimed nozzles is positioned. The nozzles are arranged in a circular pattern on the inside surface of the wide upper section so that the entire surface of the teat is treated with the high pressure air and the pre-dip solution. The side walls of the spray cylinder below the wide upper section extend inward forming a narrow neck opening that partially restricts the downward flow of high pressure air and the pre-dip solution. The side walls of the spray cylinder below the narrow neck opening extend downward, diverging and conical-shaped. The combination of the wide upper section, the downward aimed nozzles, the narrow neck opening, and the conical-shape side s on the lower section all act to create a venturi when high pressure air flows downward in the spray cylinder. The venturi creates a suction that pulls teat into the teat receiving bore and evenly distributes high pressure air and the pre-dip solution over the sides of the teat.

After the pre-dip solution has been applied and delivery to the hand piece has been discontinued, the control unit is configured to continue delivery of the high pressure air to the hand piece to remove excessive pre-dip solution from the teat, The teat is removed from the hand piece is then milked manually or with a milking machine.

After milking, the hand piece is then repositioned under the teat and high pressure air is selectively delivered to the hand piece which draws the teat into the hand piece. Once the teat is drawn into the hand piece, a post dip solution is then delivered to the hand piece. The high pressure air continues to be delivered simultaneously with the post-dip solution to the hand piece which atomizes the post-dip solution. After atomization of the post-dip solution, the high pressurized air is discontinued so that only a thick coat or layer of post-dip solution is applied to the entire teat. After application of the post dip solution, the hand piece this then removed from the tea allowed to air dry.

The hand piece includes a mode switch that the operator manipulates to select one of two operating modes—a pre-dip solution application mode; and a post-dip solution application mode. The hand piece also includes a trigger that when pressed, instructs the control unit to follow the operating mode selected by the mode switch.

The hand piece also includes a set of internal conduits that connect to external conduits that connect to storage containers that hold the high pressured air, the pre-dip solution and the post dip solution, Each storage container is coupled to a solenoid that connects to the control unit. The control unit includes a programmable logic controller, called a PLC, and a software program controls the order the solenoids are opened, and how long each solenoid is opened and closed. The software program may be programmed that enables the operator to adjust when and how long the solenoids are activated.

In another embodiment, the hand piece is modified to include an elastic bladder sleeve located inside a bladder frame that fits into a modified spray cylinder placed in the teat receiving section. The bladder is configured to squeeze against the outside surface of the teat in a downward, milking-like, coordinated manner that strips the teat after the pre-dip solution application and the drying steps have been completed

The bladder frame includes rigid side walls that converge inward and includes a laterally extending air conduit that connects to an internal conduit in the hand piece. The internal conduit connects to an external conduit that connects to a solenoid. The solenoid connects to a low pressure air source and to the control unit. The laterally extending air conduit extends through the bladder frame's side walls and terminates inside the bladder frame's inner bore. The bladder is attached at its upper and lower ends of the bladder frame and detached at the center forming an expandable cavity between the inside walls of the bladder frame and the bladder.

The side walls of the bladder are thin near its top opening and gradually thicken towards its bottom opening which allows the upper section of the bladder to expand before its lower section. When low pressure air is dispensed to expandable inner cavity, the low pressure air that forces the upper section of the bladder inward and against the sides of a teat. The low pressure air gradually flows downward into the inner cavity and causes the less flexible lower section of the bladder to expand. The combination of thin to thick side walls on the bladder sleeve and the converging side walls of the bladder frame, enable the bladder to produce a create a squeezing or wave-like expanding action against the teat.

### DESCRIPTION OF THE DRAWINGS

FIG. 1 is an illustration of the teat preparation system disclosed herein that includes a hand piece connected to a control unit.

FIG. 2. is a side elevational view of the hand piece.

FIG. 3 is a top plan view of the hand piece.

FIG. 4 is a bottom plan view of the hand piece.

FIG. 5 is a front elevational view of the hand piece.

FIG. 6 is a sectional, side elevational view of the hand piece.

FIG. 7 is a sectional, partially exploded, rear perspective view of the hand piece.

FIG. 8 is a sectional, partially exploded, front perspective view of the hand piece.

FIG. 9 is a rear elevational view of the spray cylinder.

FIG. 10 is a sectional side elevational view of the spray cylinder shown in FIG. 9.

FIG. 11 is a top plan view of the spray cylinder.

FIGS. 12, 13 and 14 are sequential, side elevational views of another embodiment of the invention that includes an elastic bladder sleeve used for stripping teat.

FIG. 15 is a front perspective view of the bladder frame.

FIG. 16 is a sectional side elevational view of the bladder frame and an elastic bladder sleeve placed therein.

FIG. 17 is a perspective view of the lower support frame.

FIG. 18 is a diagram showing the interconnections of the components used in the first embodiment of the invention.

FIG. 19 is a diagram showing the interconnections of the components used in the second embodiment of the invention that includes an elastic bladder sleeve used the stripping.

### DESCRIPTION OF THE PREFERRED EMBODIMENT(S)

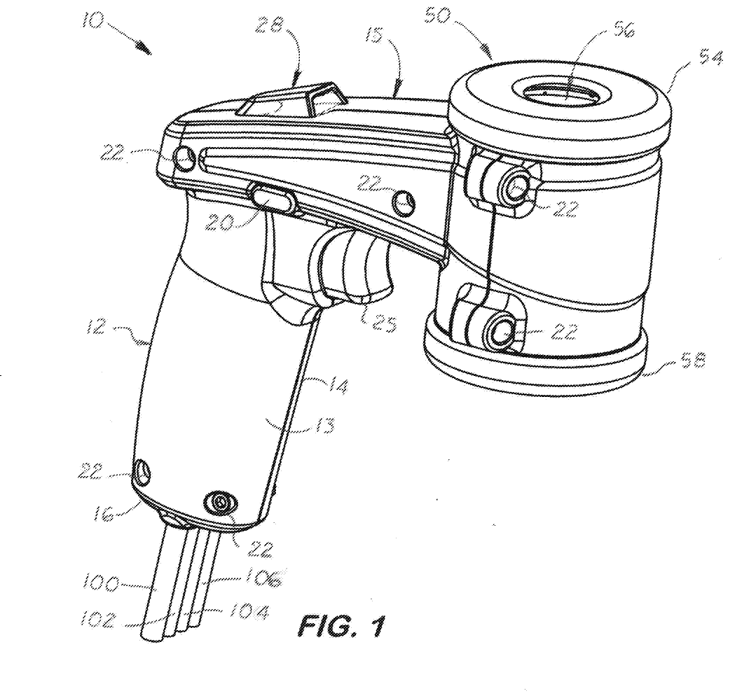

FIG. 1 shows a first embodiment of a teat preparation system 8 used to automatically and selectively clean individually the teats 200 on a bovine with a pre-dip solution 121, then dry each teat 200 without using towels, and then apply a post dip solution 127 to the each teat 200 after milking. The system 8 includes a hand piece 10 connected to a control unit 90 that controls the delivery of high pressure air 115, a pre-dip solution 121 and a post-dip solution 127 to the hand piece 10.

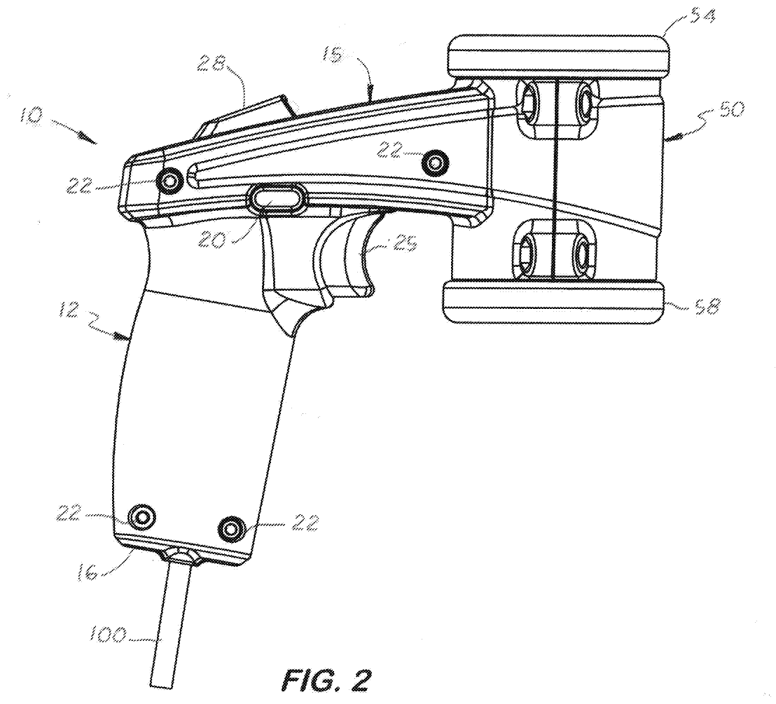

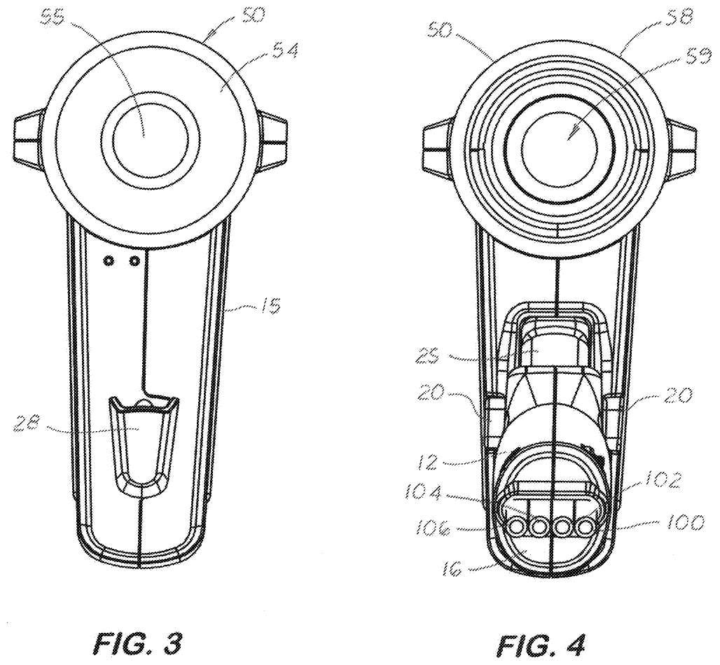

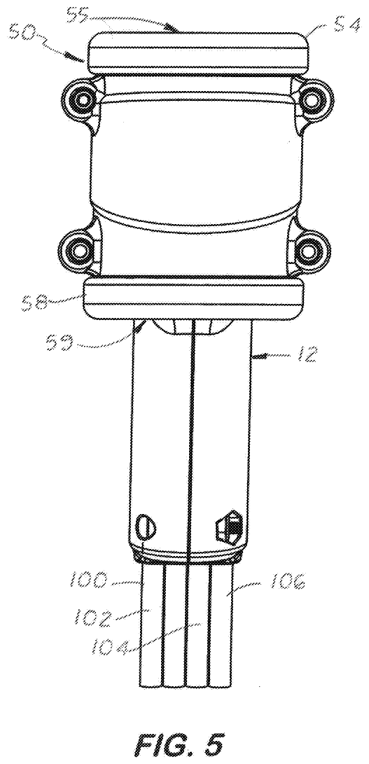

As shown in FIGS. 1-5, the hand piece 10 is a two-part, clam shell structure that forms a hollow handgrip section 12, a hollow upper support arm section 15 and a hollow teat receiving section 50. Mounted on the side of the support arm section 15 is a mode switch 20. Mounted on the front surface of the handgrip section 12 is a trigger button 25. Mounted on the top surface of the upper support arm section 15 is an optional light 28. The two half sections 13, 14 of the handgrip section 12, the support arm section 15, and the teat receiving section 50 are integrally formed and connected via thread connectors 22.

Formed on the handgrip section 12 is a trigger housing 23 containing a trigger switch 26. Mounted over the trigger switch 26 is a trigger button 25, hereinafter called a trigger. The upper support arm section 15 contains a mode switch housing 18 and a switch 21. Located inside the mode switch housing 18 is a sliding mode button 20 that moves the mode switch 21. Near the distal end of the upper support arm section 15 is a conduit end support plate 19.

The cylindrical teat receiving section 50 includes an outer housing 52 with an upper cap 54 and a lower cap 58. Formed on the upper cap 54 is a top opening 55. Formed on the lower cap 58 is a lower opening 56. Located inside the outer housing 52 is an inner cavity 53.

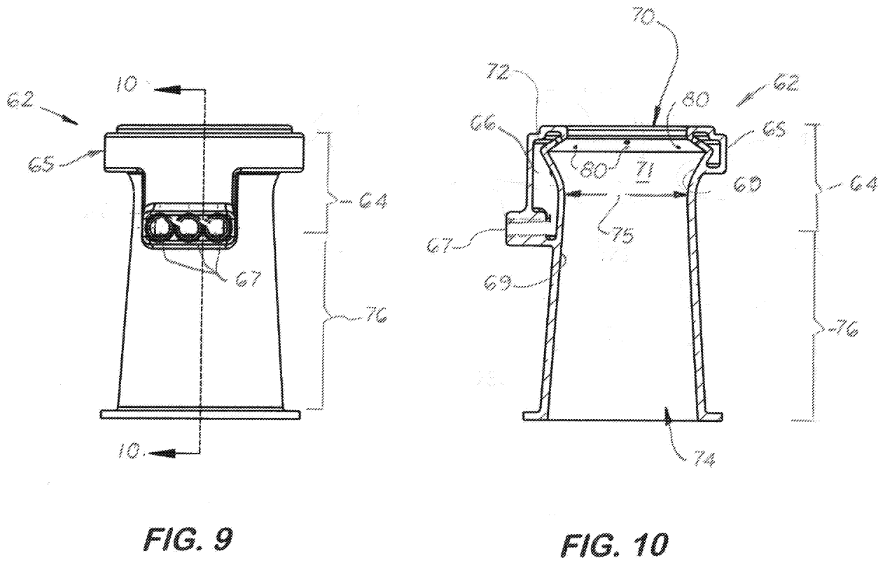

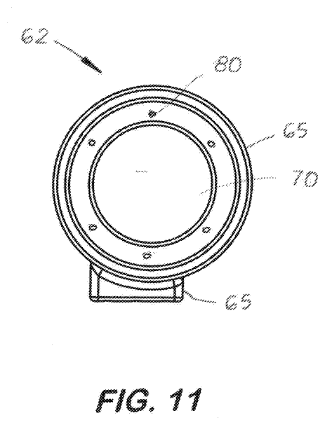

Located inside the inner cavity 53 is a cylinder-shaped spray cylinder 62. As shown in FIGS. 9, 10 and 11, the spray cylinder 62 includes an upper section 64 and a lower section 76. Formed inside the spray cylinder 62 is a center bore 63. The upper section 64 includes a collar-shaped outer housing 65 with a dosed mixing cavity 66. Formed on the lower, inside surface of the outer housing 65 are air and fluid receiving ports 67 that communicate with the mixing cavity 66. The upper section 64 and the mixing cavity 66 extends completely around the spray cylinder 62.

The spray cylinder 62 includes a narrow top opening 70 configured to fit under the upper cap 54. The top openings 55 and 70 are sufficiently wide to receive the upper portion of a teat 200. Formed on the lower end of the spray cylinder 62 is a wide bottom opening 74. During assembly, the wide bottom opening 74 is located just inside the lower opening 59.

The spray cylinder 62 includes a wide upper section 72 near the narrow top opening 70 in which a plurality of downward aimed nozzles 80 is positioned. The nozzles 80 are arranged in a circular pattern on the inside surface of the spray cylinder 62 so the entire surface of a teat 200 may be treated with high pressure air 115, a pre-dip solution 121 and a post-dip solution 127. The side walls 69 of the spray cylinder 62 below the wide upper section 72 extend inward forming a narrow neck opening 75 (see FIG. 10) that partially restricts the downward flow of high pressure air 115, the pre-dip solution 121 and the post dip solution 127 through the spray cylinder 62.

The lower section 76 of the spray cylinder 62 below the narrow neck opening 75 is conical shape, diverging and terminates at the spray cylinder's wide bottom opening 59. The combination of the wide upper section 72, the downward aimed nozzles 80, the narrow neck opening 75, and the diverging, conical-shape lower section 76 all act to create a suction that pulls a teat 200 into the spray cylinder 62 when the teat 200 is positioned ¼ to ⅓ inch above the top opening 70. Because a teat 200 after milking is flaccid, the suction also used as a stretching force that causes the teat 200 to stretch longitudinally so that post-dip solution 127 may be applied to the creases and folds commonly found a flaccid teat 200.

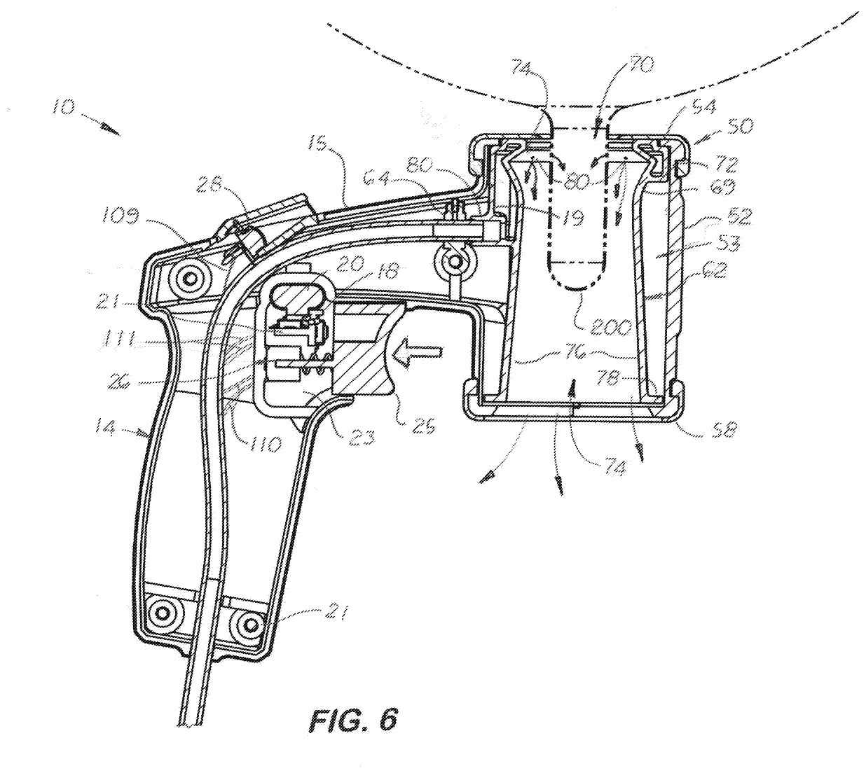

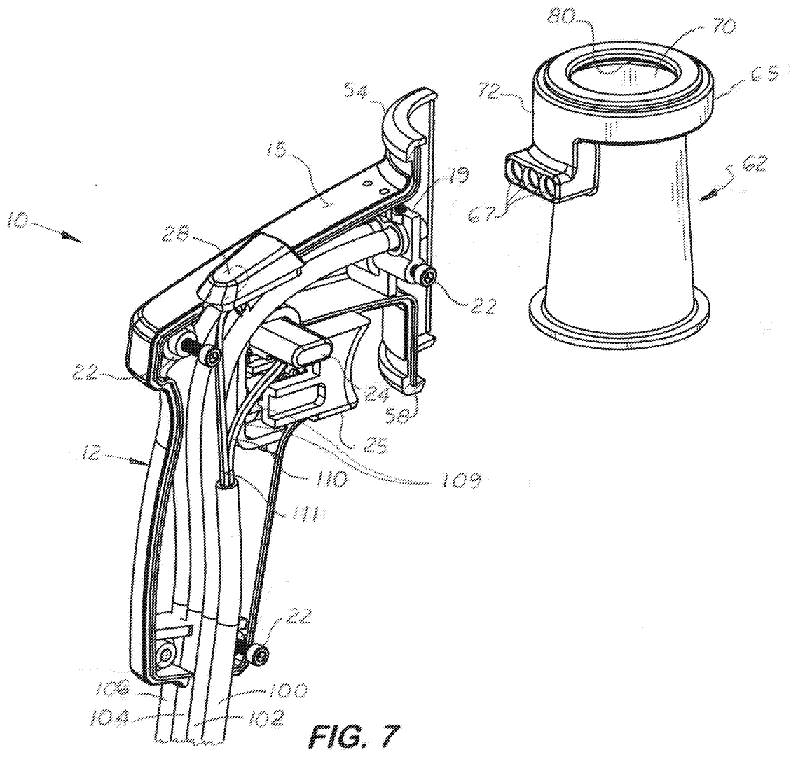

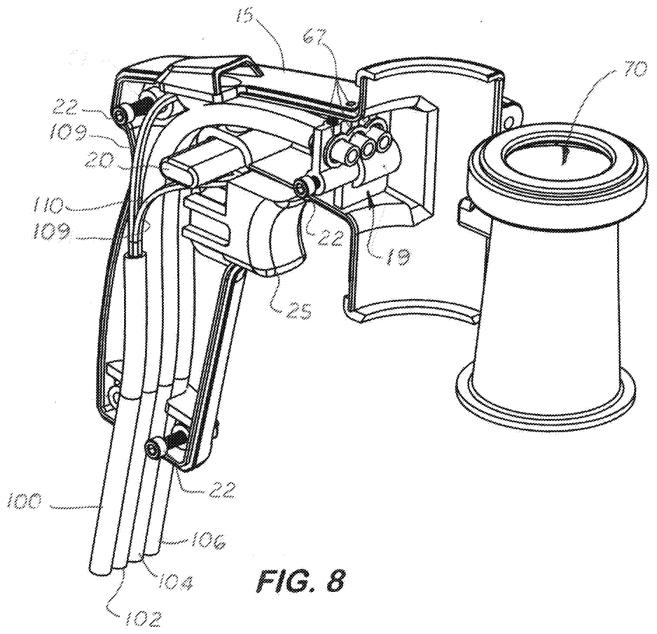

As shown in FIGS. 6-8, the hand piece 10 includes a set of internal conduits 102, 104, and 106 that extend from ports 67 formed on the conduit end support plate 19 located in the upper support arm 15. The internal conduits 102, 104, and 106 extend through the bottom end 16 of the hand grip 12 and connect to external conduits 114, 120, and 126, respectively. The external conduits 114, 120, and 126 carry high pressure air 115, pre-dip solution 121 and post dip solution 127 respectively, to the handpiece 10. During use, high-pressurized air 115, pre-dip solution 121, and post-dip solution 121 is delivered via the external conduits 114, 120, 126 to the internal conduits 102, 104 and 106, and then to the mixing cavity 66 in the teat receiving section. The high pressure air 115, pre-dip solution 121 and post-dip solution 127 then exit the mixing cavity 66 through the nozzles 80 and flow against the teat 200.

Also extending into the hand piece 12 is an electrical cable 100 that contain wires 109, 110, and 111 that connect to the light 28, the mode switch 21 and the trigger switch 26, respectively. The end of electrical cable 100 connects to the control unit 90.

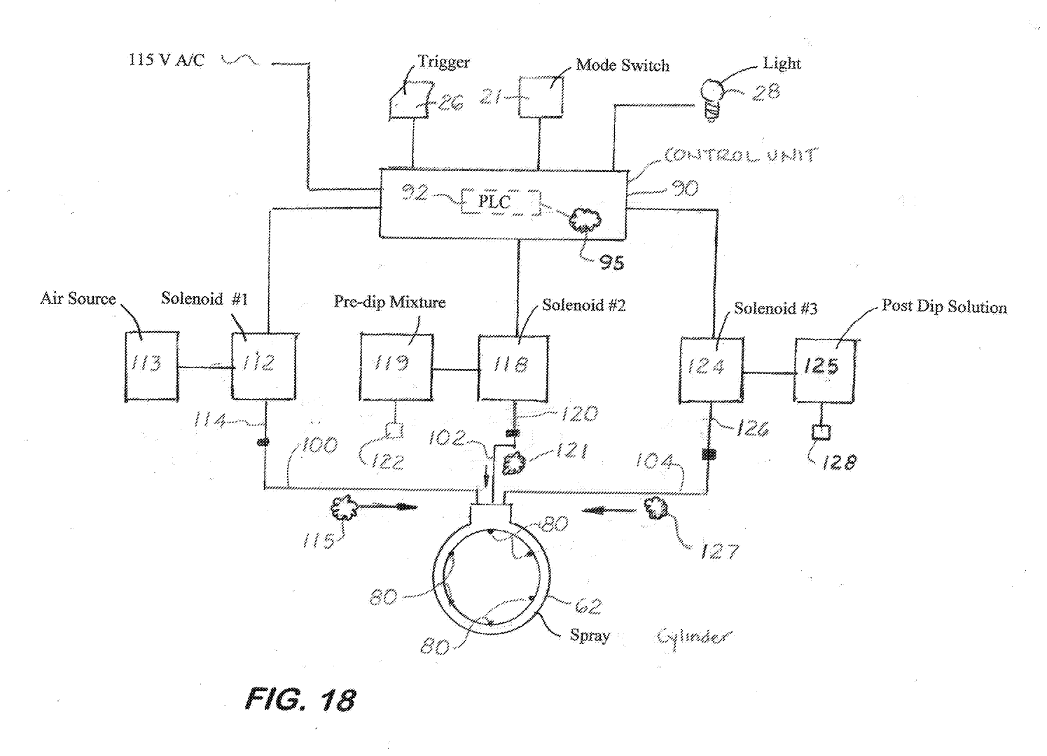

The control unit 90 includes a programmable logic control, called a PLC indicated by the reference number 92, with a software program 95 loaded into its working memory. The PLC 92 and the software program 95 are configured to precisely control the delivery of high pressure air 115, pre-dip solution 121 and post-dip solution 127 to the hand piece 10. As shown in FIG. 18, the control unit 90 is connected to a first solenoid 112, a second solenoid 118, and a third solenoid 124. The first solenoid 112 is connected to a pressure air source 113 and to an external conduit 114 that connects to the internal conduit 102 inside the hand piece 10. The second solenoid 118 is connected to a pre-dip solution source 119 and to the external conduit 120 that connects to an internal conduit 102 inside the hand piece 10. The pre-dip solution 121. may be delivered to an optional heater 128 connected to the conduit 120 that pre-heats the pre-dip solution 121 to approximately 90 to 120 degrees F prior to delivery to the internal conduit 102.

Third solenoid 124 is connected to a post-dip solution source 125 and to an external conduit 126 that connects to internal conduit 106 inside the hand piece 10. The third solenoid 124 may also be connected to an optional heater 129 connected to the conduit 126 that pre-heats heats the post-dip solution 127 to approximately 90 to 120 degrees F. prior to delivery to the nozzles 80.

As discussed further below, the software program 95 is configured to control when and how long each solenoid 112, 118, and 124 opens and closes. During use, the operator manipulates the mode switch 21 to select one of two operating modes—a pre-dip solution application mode: and a post-dip solution application mode. The two modes determine which solenoid opens and closes and how long. The operator then manipulates the trigger 25 to initiate the operating mode selected by the mode switch 21.

### Operation of the Cleaning, Pre-dip Application, and Post-dip Solution Embodiment

In the first embodiment (no bladder sleeve), when the mode switch 21 is moved to the first mode position and the operator presses the trigger 25, the PCL 92 is activated which. runs the first stage mode routine. During the first mode routine, the software program 95 and the PLC 92 opens the first solenoid 112 connected to the pressure air source 113 containing high pressure air 115 (approximately 150 PSI). During the first mode routine, the second solenoid 118 is opened simultaneously with the first solenoid 112. When the second solenoid 118 is opened, pre-dip solution 121 is delivered to the hand piece 10. When the second solenoid 118 is activated, the optional heater 129 may also be activated to heat the pre-dip solution 121.

The software program 95 is configured to open both the first and second solenoids 112, 118, respectively, when the trigger 25 is continuously pressed. Both high pressure air 115 and the pre-dip mixture 121 are delivered to the hand piece 10 and discharged from the nozzles 80. The first and second solenoids 112, 118 remain open as long as the trigger 25 is pressed.

When the trigger 25 is released, the software program 95 is configured to immediately close the second solenoid 118 thereby discontinuing delivery of the pre-dip solution 121 to the nozzles 80. The software program 95 control the PLC 92 so that the first solenoid 112 remains open for approximately 2 seconds after the second solenoid 118 closes allowing only high pressure air 115 to flow from the nozzles 80 and remove excessive pre-dip solution 121 from the surface of the teat 200. If the operator presses the trigger 25 again while the first solenoid 112 is opened and the second solenoid 118 is closed, then first stage mode routine automatically re-runs.

When the mode switch 21 is moved to the post-dip application mode position and the trigger 25 is pressed, the PCL 92 runs the second stage mode routine. In the second stage mode routine, the first solenoid 112 opens to deliver high pressure air 115 to the nozzles 80. The first solenoid 112 is open as long as the trigger 25 is pressed. When the trigger 25 is released, the third solenoid 124 opens to deliver post-dip solution 127. If the third solenoid 124 is connected to an optional heater 129, the post-dip solution 127 is heated prior to delivery to the hand piece 10.

When the trigger 25 is released, the first solenoid 112 remains open for 0.25 to 0.5 seconds allowing high pressure air 115 to be released from the nozzles 80 and mixed with the post-dip solution 127. The mixture of high pressure air 115 and post-dip solution 127 causes the post-dip solution 127 to atomize and spread across the entire surface of the teat 200. The software program 95 is also configured to keep the third solenoid 124 open 0.25 to 0.5 seconds after the first solenoid 112 closes so that the entire teat 200 is wetted with post-dip solution 127.

### Stripping Embodiment

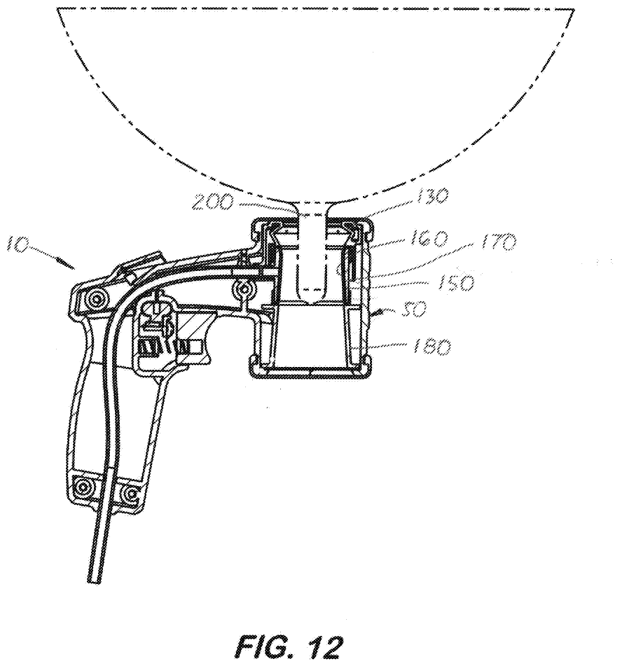

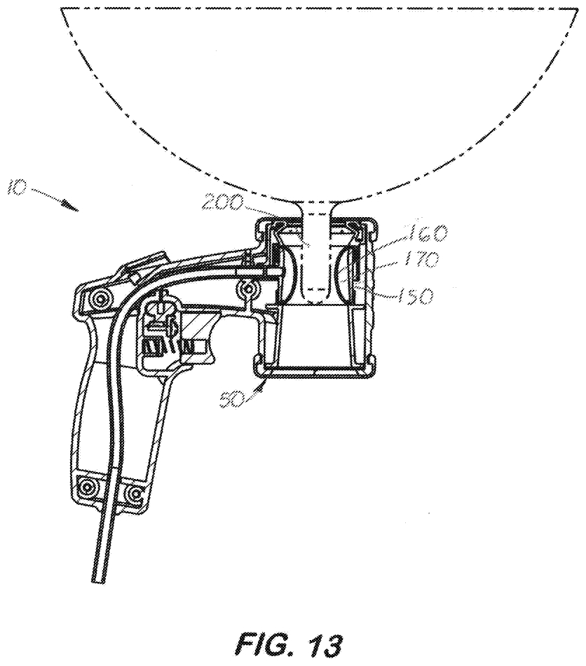

FIGS. 12-17 and 19 show a second embodiment of the system 10 that includes the hand piece 10 and control unit 90 used in the first embodiment discussed above. In the second embodiment, the software program is re-programmed or replaced by a modified software program 96 and the spray cylinder 62 is replaced by a modified spray cylinder 130. The modified spray cylinder 130 includes the same upper section 64 with an outer housing 65, a mixing cavity 66 and nozzles 80. During use, a teat 200 is placed over the top opening of the upper section 64 and drawn into the center bore. High pressure air 115, pre-dip solution 121 and post-dip solution 127 are then delivered to and dispensed from the nozzles 80 as described above in the spray cylinder 62.

The modified spray cylinder 130 is configured to rest over a cylindrical, inflating member 140 placed inside the teat receiving section 50. The inflating member 140 is stacked above a short conical support structure 180.

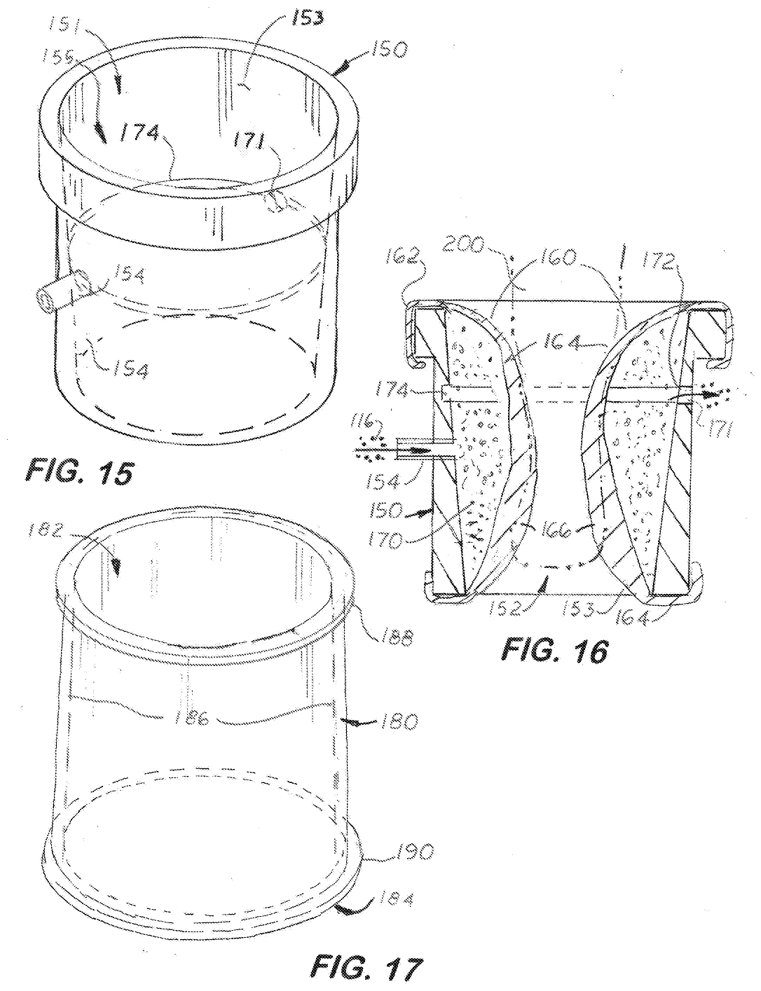

The inflating member 140 includes a cylindrical bladder frame 150 that fits into the teat receiving section 50. As shown in FIG. 15, the bladder frame 150 includes a top opening 151, a bottom opening 152 and sidewalls 153 that converge in a downward direction forming a conical-shaped center passageway 155. Extending through a sidewall 153 is a laterally extending air inlet 154 that communicates with a center passageway 155 formed in the bladder frame 150. The air inlet 154 is located near the middle section of the bladder frame 150. Also formed on the bladder fame 150 is a small exhaust port 171 located on the opposite side of the bladder frame 105 that also communicates with the inner air cavity 170. Extending along the inside surface of the sidewall 152 and aligned with the exhaust port 171 formed on the bladder frame 150 is a circular channel 174.

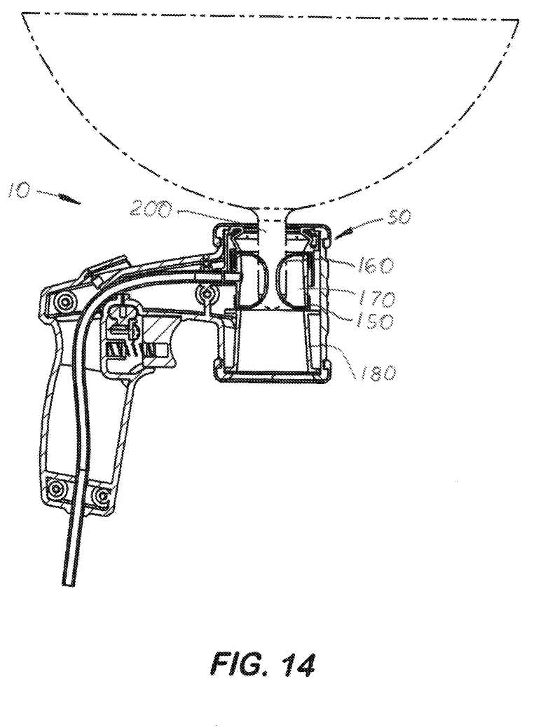

As shown in FIG. 14, the bladder frame 150 rests on top of a short conical support structure 180 that fits inside the teat receiving body 50. The conical support structure 180 includes a top opening 182, and a bottom opening 184. Formed around the top opening 182 is a wide diameter upper lip 188. Formed around the inside diameter of the short conical support 180 are diverging sidewalls 186.

As shown more clearly in. FIGS. 12, 13, 14 and 16, located inside the bladder frame 150 is an elastic bladder sleeve 160 is configured to sequentially expand and relax-to repeatingly against the sides of a teat 200, The bladder sleeve 160 is a ballooning, cylindrical-shaped structure with thin upper sidewall 164 (approx. 1 ml thick) relatively thick lower sidewalls 166 (approximately 3 to 4 mls thick). The bladder sleeve 160 includes a circular upper edge 162 configured to stretch over the upper edge of the bladder frame 150 and a lower edge 164 configured to stretch over the lower edge of the bladder frame 150. The upper and lower edges 162, 164 affix the bladder sleeve 160 to the bladder frame 150. The inside surface of the sidewalls of the bladder sleeve 160 extend inward and narrows from top to bottom and then extend outward to form an adjustable, hour-glass shape center passageway 166 in which the teat 200 is placed.

When the bladder sleeve 1.60 is assembled on the bladder frame 150, the center, outside side walls of the bladder sleeve 160 are detached from the bladder frame 150. An inner air space 170 is formed between the inside surface of the bladder frame 150 and the outside surface of the bladder sleeve 160. The air space 170 is partially closed so that air trapped inside the inner air space 170 escapes only through the exhaust port 171. Because the center passageway 166 has an hour-glass configuration and the thickness of the sidewall 164 of the bladder sleeve 160 is thinner in the upper portion and therefore more flexible than the lower portion of the bladder sleeve 160, the upper portion of the bladder sleeve 160 expands inward before the lower portion to gradually squeeze the teat 200 in a downward, wave-like manner. Because the upper portion of the bladder sleeve 160 is relatively thin (1 to 2 mls), low pressure air 116 (approximately 50 PSI) must be used to expand the bladder sleeve 160.

During use, delivery of the low pressure air 116 to the inner air spaced. 170 is repeated continued and discontinued (called inflation/deflation cycles) to create a plurality of squeezing, milking-like movements against the teat 200. When delivery of the low pressure air 116 is discontinued, the low-pressure air 116 in the inner air space 170 slowly escapes from the inner air space 170 via the exhaust port 171. Because the circular recessed channel 174 is formed in the inside surface of the bladder frame 150 that communicates with the exhaust hole 172, any air blocked by the collapsing bladder sleeve 160 may escape through the exhaust hole 172.

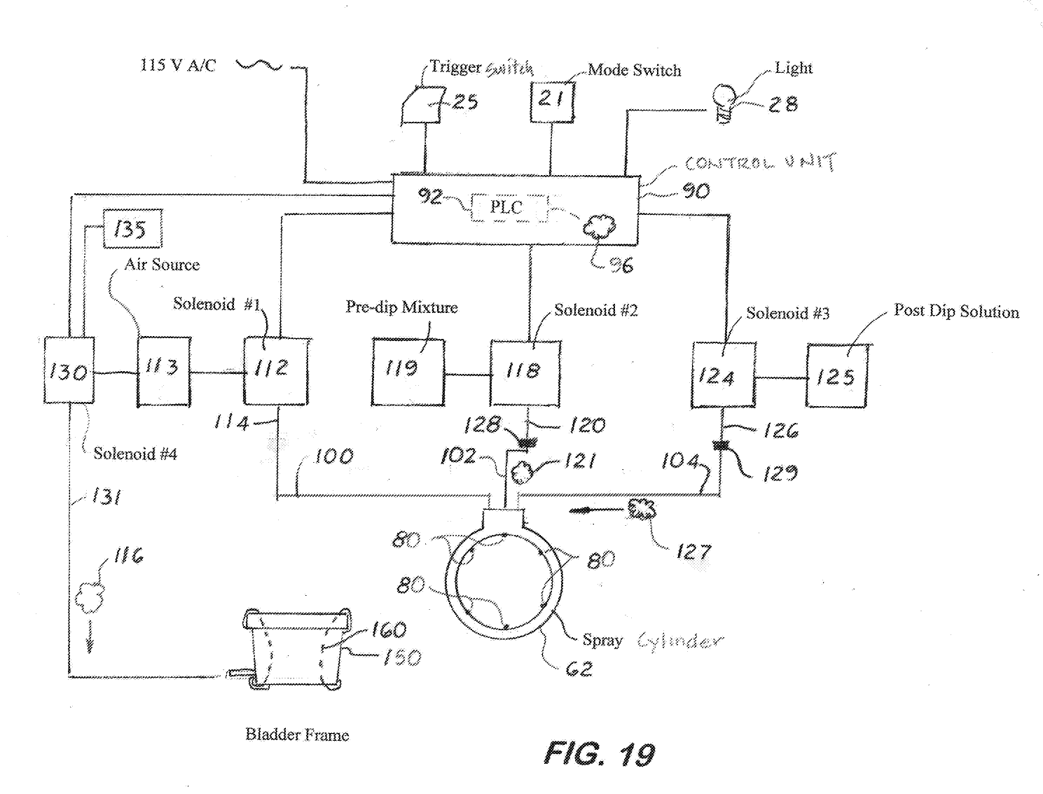

Delivery of the low pressure air 116 is controlled by the PCL 92 and the modified software program 96. As shown in FIG. 19, the control unit 90 is connected to a fourth solenoid 132 that is connected to a low pressure air source 135 (approximately 50 PSI). It should be understood that the fourth solenoid 132 may be connected to high pressure air source 113 and configured to lower the air pressure from 150 PSI to approximately 50 PSI.

A conduit 133 runs from the fourth solenoid 132 to the hand piece 10 and to the air outlet conduit 156 inside the hand piece 10 and then to the bladder frame 150.

### Operation of Stripping Embodiment

Washing stage and drying stage used in this embodiment are identical to the washing stage and drying stage used in the first embodiment. The only difference is that in the second embodiment, the system 8 strips the teat 200 after applying the pre-dip solution 121.

Immediately after the drying step in the pre-dip application stage is completed, the software program 95 and PCL 92 automatically begins a stripping mode that involves opening and closing the fourth solenoid 132 connected to the lower pressure source 135 or to the high pressurized air source 113. The fourth solenoid 132 connects to an external conduit 133 that connects to an air outlet conduit 156 inside the hand piece 10. The air outlet conduit 156 connects to the inner air space 170. Air escapes from the inner air space 170 via the exhaust port 171.

The cyclic, ON/OFF operation of the fourth solenoid 132 is controlled by the PCL 90 and the software program 95. During the stripping stage, 3 to 4 inflation and deflation cycles are performed. Each cycle consists of delivering low pressurized air 116 to the inner air space 170 for approximately 0.5 seconds followed by a discontinuation period of approximately 0.5 seconds which enables the low pressurized air 116 to escape. After the stripping step has been completed, the operator then moves the mode switch 21 to the second mode operation position. When the operator then presses the trigger 25, the PCL 92 is activated and runs the post-dip application mode routine which opens the first solenoid 112 (high pressure air). When the trigger 25 is released, the third solenoid 124 opens to deliver post-dip solution 127 to the nozzles 80. When the trigger 25 is released, the first solenoid 112 remains open for 0.25 to (0.5) seconds allowing high pressure air 115 to be released from the nozzles 80 and mixed with the post dip solution 127 and atomize the last volume of post dip solution 127 exiting the nozzles 80. The third solenoid 124 remains open 0.25 to 0.5 sec after the first solenoid 112 closes so the entire teat 200 is wetted with a layer of post dip solution 127.

In summary, the above system 8 uses high pressure air delivered to a hand piece 10 to apply a pre-dip solution 121 and a post-dip solution 127 to a teat 200. The hand piece 10 includes a spray cylinder 62 or a modified spray cylinder 130 with nozzles 80 to evenly spray high pressure air 115, the pre-dip solution 121, and post-dip solution 127 around the teat 200. Below the spray cylinder 62 or the modified spray cylinder 130 is a venturi generated device that creates a vacuum that draws and stretches the teat 200 inside the teat receiving section. The system 8 can also be easily modified to include a stripping feature that strips the teat 200 before applying the post-dip solution 127.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

1. A teat preparation system, comprising:
a. a hand piece that includes a hand grip section and a teat receiving section, the teat receiving section includes a spray cylinder with a center bore configured to receive a teat, the spray cylinder includes an upper edge and a plurality of nozzles aimed inward to deliver pressurized air, a pre-dip solution and a post-dip solution to the center bore, said. spray cylinder also includes a narrow neck and a conical-shaped, lower section located below said narrow neck that create a venturi when high pressure air flows downward through said center bore; and
b. a control unit connected to said hand piece and to a high air pressure source, a pre-dip solution source and a post-dip solution source, said control unit configured to operate in a first mode that selectively delivers both said high pressure air and said pre-dip solution to said spray cylinder and then discontinues the delivery of said pre-dip solution but continues to deliver of said high pressure air, said control unit also configured to operate in a second mode that selectively delivers both said high pressure air and said post-dip solution to said spray cylinder and then discontinues the delivery of said high pressure air and but continues delivery of said post-dip solution.

2. The teat preparation system, as recited in claim 1, further including a bladder frame located inside said teat receiving section and below said bladder frame, said bladder frame includes an elastic bladder sleeve with an inner air cavity formed between said bladder frame and said bladder sleeve, said bladder sleeve configured to sequentially expand inward in a top to bottom manner press against and milk a teat placed inside said center bore when air is delivered to said inner air cavity.

3. The teat preparation system, as recited in claim 2, wherein said control unit controls the delivery of said air to said bladder frame.

4. A teat preparation system, comprising:
a. a control unit connected to air pressure source, a pre-dip mixture source and a post dip mixture source, said control unit includes a programmable logic controller;
b. a hand piece connected to said control unit, said hand piece includes a mode switch coupled to said control unit that moves to a first position to operate said control unit in a first operating mode or to a second operating mode to operate said control unit in a second operating mode, said hand piece also includes a trigger that activates said control unit, said hand piece includes teat receiver section with a top opening configured to receive a dairy animal teat and a lower conical area with a lower opening arid with downward extending, diverging side walls, located inside said teat receiving section and near said top opening is a spray ring with a plurality of nozzles aimed inward and downward; and,
c. a software program loaded into the programmable logic controller and configured to operate said control unit in said first operating mode and when said trigger is activated or configured to operate said control unit in a second operation mode and when said trigger is activated, when said mode switch is activated to said first mode position and said trigger is activated, said programmable logic controller causes both said high pressure air and said pre-dip solution to be delivered to said nozzles in said spray ring and discontinue the delivery of said pre-dip solution and continue the delivery of said high pressure air, when said mode switch is activated to a second mode position and said trigger is activated, said programmable logic controller causes both said high pressure air and said post-dip solution to be delivered to said nozzles and discontinue the delivery of said high pressure air after a predetermine period but continue the delivery of said post-dip solution a predetermined period after delivery of said high pressure air as been discontinued.

5. The teat preparation system, as recited in claim 4, further including a first solenoid connected to said control unit, said programmable logic controller and said software program configured to control said first solenoid and release said high pressure air from said air pressure source when said mode switch is moved to a first position and said trigger is activated.

6. The teat preparation system, as recited in claim 4, further including a second solenoid connected to said control unit, said programmable logic controller and said software program configured to control said second solenoid configured to release pre-dip solution from said pre-dip solution source when said mode switch is moved to a first position and said trigger is activated.

7. The teat preparation system, as recited in claim 5, further including a second solenoid connected to said control unit, said programmable logic controller and said software program configured to control said second solenoid configured to release said pre-dip solution from said pre-dip solution source when said mode switch is moved to a first position and said trigger is activated.

8. The teat preparation system, as recited in claim 4, further including a first solenoid connected to said control unit, said programmable logic controller and software program configured to control said first solenoid and release said high pressure air from said air pressure source when said mode switch is moved to a second position and said trigger is activated.

9. The teat preparation system, as recited in claim 4, further including a third solenoid connected to said control unit, said programmable logic controller and said software program configured to control said third solenoid and release said post-dip solution from said post-dip solution source when said mode switch is moved to a second position and said trigger is activated.

10. The teat preparation system, as recited in claim 8, further including a third solenoid connected to said control unit, said programmable logic controller and said software program configured to control said third solenoid and release said post-dip solution from said post-dip solution source when said mode switch is moved to a second position and said trigger is activated.

1. The teat preparation system, as recited in claim 5, further including a third solenoid connected to said control unit, said third solenoid configured to release post-dip solution from said post-dip solution container when said mode switch is moved to a second position and said trigger is activated.

12. The teat preparation system, as recited in claim 6, further including a third solenoid connected to said control unit, said third solenoid configured to release post-dip solution from said post-dip solution container when said mode switch is moved to a second position and said trigger is activated.

13. The teat preparation system, as recited in claim 5, further including a bladder frame located inside said teat receiver section, said bladder frame includes a bladder sleeve with an inners cavity formed between said bladder frame and said bladder sleeve, said bladder sleeve configured to inflate inward and apply a milking force to said teat placed inside said teat receiving section, said programmable logic control and software program configured to deliver and discontinue the flow of pressurize air to said inner cavity to selectively inflate and deflate said bladder sleeve and thereby strip said teat.

14. The teat preparation system, as recited in claim 8, further including a bladder frame located inside said teat receiver section, said bladder frame includes a bladder sleeve with an inners cavity formed between said bladder frame and said bladder sleeve, said bladder sleeve configured to inflate inward and apply a milking force to said teat placed inside said teat receiving section, said programmable logic control and software program configured to deliver and discontinue the flow of pressurize air to said inner cavity to selectively inflate and deflate said bladder sleeve and thereby strip said teat.

15. The teat preparation system, as recited in claim 10, further including a bladder frame located inside said teat receiver section, said bladder frame includes a bladder sleeve with an inners cavity formed between said bladder frame and said bladder sleeve, said bladder sleeve configured to inflate inward and apply a milking force to said teat placed inside said teat receiving section, said programmable logic control and software program configured to deliver and discontinue the flow of pressurize air to said inner cavity to selectively inflate and deflate said bladder sleeve and thereby strip said teat.

16. The teat preparation system, as recited in claim 3, further including a light mounted on said hand piece configured to illuminate said teat.

17. A method for pre-milking treatment and post milking treatment of a dairy animal teat, comprising the following steps:
a providing a teat preparation system that includes a control unit and a hand piece, said control unit connected to a first solenoid connected to an air pressure source, and to a second solenoid connected to a pre-dip mixture and to a third solenoid connect to a post dip solution, said hand piece includes a mode switch that moves in a first position to operate said control unit in a first operating mode or moves to a second to operate said control unit is a second operating mode, said hand piece includes teat receiver section with a top opening configured to receive a dairy animal teat, formed near said top opening is a spray ring with a plurality of nozzles aimed inward and downward, said hand piece includes a trigger configured to be manually activated to said control unit according to the position of said mode switch, said control switch programmed to operate said first solenoid and said second solenoid to wash and dry said teat when said mode switch is moved to a first position and said trigger is activated, said control switch also programmed to operate said first solenoid and said third solenoid to deliver air and post dip solution to said teat when said mode switch is placed in a second position and said trigger is activated; inserting the dairy animal teat into said teat receiver section;
c. moving said mode switch to said first position;
d. activating and holding said trigger to deliver high pressure air and pre-dip solution to said nozzles,
e. releasing said trigger which discontinues release or pre dip solution to said nozzles and continues the delivery of high pressure air from said nozzles;
f. removing said teat from said teat receiver body to milk said teat;
g. after milking, inserting said into said teat receiver section;
h. moving said mode switch to a second position;
i. activating and holding said trigger to dispense high pressure air and post-dip solution to said teat; and,
j. releasing said trigger which discontinues the delivery of high pressure air to said teat receiver section and discontinues the delivery of pos-dip solution after the delivery of the high pressure air has been discontinued.

18. The method as recited in claim 17 wherein said teat preparation system includes a bladder frame located inside said teat receiving section, said bladder frame includes an elastic bladder sleeve configured tai inflate inward against the sides of a teat when placed inside said teat receiving section, said control unit also programmed to selective deliver air to said bladder frame to inflate said bladder sleeve, said method includes the step of delivering pressurized air to said bladder frame after activating and holding said trigger to deliver high pressure air and pre-dip solution to said nozzles.
